(19) United States
(12) Patent Application Publication
(10) Pub. No.: US 2025/0276694 A1
(43) Pub. Date: Sep. 4, 2025

(54) MOVING BODY CONTROL DEVICE, MOVING BODY CONTROL METHOD, AND STORAGE MEDIUM

(71) Applicant: HONDA MOTOR CO., LTD., Tokyo (JP)

(72) Inventor: Nozomu Hirosawa, Tokyo (JP)

(21) Appl. No.: 19/056,811

(22) Filed: Feb. 19, 2025

(30) Foreign Application Priority Data
Mar. 4, 2024 (JP) 2024-032157

(51) Int. Cl. B60W 30/18

(52) U.S. Cl. CPC B60W 30/18163; B60W 2420/403; B60W 2420/408; B60W 2556/50; B60W 2720/12

(57) ABSTRACT

A moving body control device includes a lane change controller configured to change a lane of a moving body from a first lane in which the moving body is located to a second lane adjacent to the first lane regardless of an operation of an occupant, the lane change controller configured to stop control related to the lane change when a predetermined event continues during a first time, and a setting change part configured to change setting of the first time on the basis of setting information of the lane change.

### CROSS-REFERENCE TO RELATED APPLICATION

Priority is claimed on Japanese Patent Application No. 2024-032157, filed Mar. 4, 2024, the content of which is incorporated herein by reference.

### BACKGROUND OF THE INVENTION

### Field of the Invention

The present invention relates to a moving body control device, a moving body control method, and a storage medium.

### Description of Related Art

In recent times, there have been increasing attempts to provide access to a sustainable transportation system that takes into consideration the most vulnerable traffic participants. To achieve this, we are focusing on research and development in autonomous driving and advanced driver assistance to further improve traffic safety and convenience. In this technology, it is an important element to keep various types of setting information at appropriate values. For example, Japanese Unexamined Patent Application, First Publication No. 2023-154345 discloses determining a lane change starting section so that lane changes can be performed based on the driver's preferences.

### SUMMARY OF THE INVENTION

Incidentally, a plurality of pieces of setting information in autonomous driving or advanced driver assistance can be provided. In the technology in the related art, no consideration was given to reflecting other setting information when changing one piece of setting information. For this reason, there was a possibility that the setting information was not set properly.

An aspect of the present invention is directed to providing a moving body control device, a moving body control method, and a storage medium that are capable of appropriately setting a reference time for cancelling a lane change, which is one piece of setting information. Furthermore, an aspect of the present invention is directed to contributing to development of a sustainable transportation system.

A moving body control device, a moving body control method, and a storage medium according to the present invention employ the following configurations.
(1) A moving body control device according to an aspect of the present invention includes a lane change controller configured to change a lane of a moving body from a first lane in which the moving body is located to a second lane adjacent to the first lane regardless of an operation of an occupant, the lane change controller configured to stop control related to the lane change when a predetermined event continues during a first time; and a setting change part configured to change setting of the first time on the basis of setting information of the lane change.
(2) In the aspect of the above-mentioned (1), the setting information is a second time from a time when the lane change controller determines to perform the control related to the lane change until the moving body starts a lateral movement for the lane change, and the setting change part sets the first time shorter as the second time becomes shorter.
(3) In the aspect of the above-mentioned (1), the setting information is a lateral velocity in the lane change, and the setting change part sets the first time shorter as the lateral velocity becomes greater.
(4) In the aspect of the above-mentioned (1), the setting change part changes the setting of the first time according to an export destination country of the moving body.
(5) In the aspect of the above-mentioned (1), the lane change controller does not stop the control related to the lane change when a predetermined place of the moving body crosses a road division line during a first time even if the predetermined event continues during the first time.
(6) In the aspect of the above-mentioned (1), the lane change controller does not stop the control related to the lane change when the moving body starts a lateral movement for the lane change during a first time even if the predetermined event continues during the first time.
(7) In the aspect of the above-mentioned (1), the predetermined event is when the occupant does not grip a steering operator.
(8) A moving body control device according to another aspect of the present invention includes a lane change controller configured to change a lane of a moving body from a first lane in which the moving body is located to a second lane adjacent to the first lane regardless of an operation of an occupant, the lane change controller configured to stop control related to the lane change when a predetermined event continues during a first time, the first time is set to be shorter as a second time is shorter, the second time being a time from when the lane change controller has determined to perform control related to the lane change until the moving body starts a lateral movement for the lane change.
(9) A moving body control method according to another aspect of the present invention is a moving body control method executed by a moving body control device, the moving body control method including: processing of changing a lane of a moving body from a first lane in which the moving body is located to a second lane adjacent to the first lane regardless of an operation of an occupant and stopping control related to the lane change when a predetermined event continues during a first time; and processing of changing setting of the first time on the basis of setting information of the lane change.
(10) A storage medium according to another aspect of the present invention is a computer-readable non-transitory storage medium in which a program is stored to cause a processor of a moving body control device to execute: processing of changing a lane of a moving body from a first lane in which the moving body is located to a second lane adjacent to the first lane regardless of an operation of an occupant and stopping control related to the lane change when a predetermined event continues during a first time; and processing of changing setting of the first time on the basis of setting information of the lane change.

According to the aspects of the above-mentioned (1) to (10), a reference time of lane change stop, which is one of setting information, is set appropriately.

### BRIEF DESCRIPTION OF THE DRAWINGS

FIG. 1 is a view showing a part of a configuration of a vehicle in which a vehicle control device is mounted.

FIG. 2 is a functional configuration view of a first controller and a second controller.

FIG. 3 is a view illustrating a scene in which an automatic lane change is performed.

FIG. 4 is a flowchart showing an example of a flow of processing by a lane change controller.

FIG. 5 is a view illustrating a scene in which an occupant feels uncomfortable with the cancellation timing of an automatic lane change.

FIG. 6 is a view showing an example of a setting information change table.

FIG. 7 is a flowchart showing an example of a flow of processing executed by a setting change part.

### DETAILED DESCRIPTION OF THE INVENTION

Hereinafter, embodiments of a moving body control device, a moving body control method, and a storage medium of the present invention will be described with reference to the accompanying drawings. A moving body is something that moves in a region, such as a road having lanes, and may include so-called vehicles as well as any other autonomously mobile object, such as a self-propelled robot, an electric kick scooter, or the like. In the following description, it will be referred to as a vehicle control device, which is an example of the moving body control device. The driving source of the vehicle controlled by the vehicle control device is an internal combustion engine such as a diesel engine or a gasoline engine, an electric motor, or a combination of these. The electric motor runs on electricity generated by a generator connected to the internal combustion engine, or on electricity discharged from a secondary battery or fuel cells.

### [Configuration]

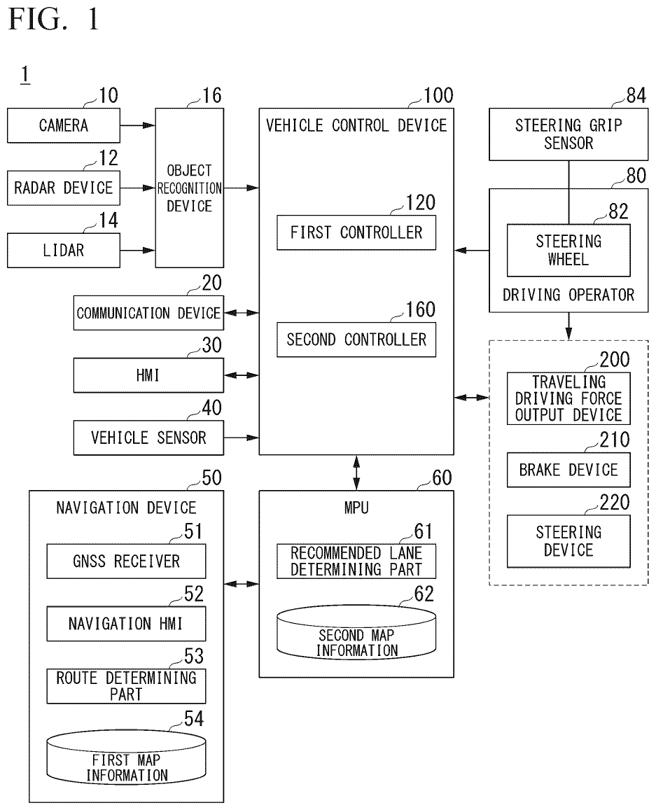

FIG. 1 is a view showing a part of a configuration of a vehicle M in which a vehicle control device 100 is mounted. The vehicle M includes, for example, a camera 10, a radar device 12, a light detection and ranging (LIDAR) 14, an object recognition device 16, a communication device 20, a human machine interface (HMI) 30, a vehicle sensor 40, a navigation device 50, a map positioning unit (MPU) 60, a driving operator 80, the vehicle control device 100, a traveling driving force output device 200, a brake device 210, and a steering device 220. These devices and equipment are connected to each other by multiple communication lines, such as a controller area network (CAN) communication line, serial communication lines, wireless communication networks, or the like. Further, the configuration shown in FIG. 1 is merely an example, and some of the configuration may be omitted, or other configuration may be added.

The camera 10 is a digital camera using a solid-state imaging device such as a charge coupled device (CCD), a complementary metal oxide semiconductor (CMOS), or the like. The camera 10 is attached to an arbitrary place on the vehicle M. When capturing an image of the front, the camera 10 is attached to a front windshield upper portion, a rearview mirror back surface, or the like. The camera 10 captures images of the surroundings of the vehicle M repeatedly, for example periodically. The camera 10 may be a stereo camera.

The radar device 12 emits radio waves, such as millimeter waves, around the vehicle M and detects the radio waves reflected by objects (reflected waves) to detect at least a position (distance and azimuth) of the object. The radar device 12 is attached to an arbitrary place on the vehicle M. The radar device 12 may detect the position and speed of the object using a frequency modulated continuous wave (FM-CW) method.

The LIDAR 14 emits light (or electromagnetic waves with a wavelength close to the light) to the surroundings of the vehicle M, and measures scattered light. The LIDAR 14 detects the distance to the subject on the basis of the time between light emission and reception. The emitted light is, for example, a pulsed laser beam. The LIDAR 14 is attached to an arbitrary place on the vehicle M.

The object recognition device 16 performs sensor fusion processing on some or all of the detection results from the camera 10, the radar device 12, and the LIDAR 14 to recognize the position, the type, the speed, or the like, of the object. The object recognition device 16 outputs the recognition results to the vehicle control device 100. The object recognition device 16 may output the detection results of the camera 10, the radar device 12, and the LIDAR 14 to the vehicle control device 100 without modifying them. The object recognition device 16 may be omitted from a vehicle system 1.

The communication device 20 communicates with other vehicles in the vicinity of the vehicle M using, for example, a cellular network, a Wi-Fi network, Bluetooth (Registered trademark), dedicated short range communication (DSRC), etc., or communicates with various server devices via a wireless base station.

The HMI 30 presents various pieces of information to the occupant of the vehicle M and accepts input operations from the occupant. The HMI 30 includes various display devices, a speaker, a buzzer, a touch panel, a switch, a key, and the like.

The vehicle sensor 40 includes a vehicle speed sensor configured to detect a speed of the vehicle M, an acceleration sensor configured to detect acceleration, a yaw rate sensor configured to detect an angular speed around a vertical axis, an azimuth sensor configured to detect an orientation of the vehicle M, and the like.

The navigation device 50 includes, for example, a global navigation satellite system (GNSS) receiver 51, a navigation HMI 52, and a route determining part 53. The navigation device 50 holds first map information 54 on a storage device such as a hard disk drive (HDD), a flash memory, or the like. The GNSS receiver 51 specifies a position of the vehicle M on the basis of the signal received from a GNSS satellite. The position of the vehicle M may be specified or supplemented by an inertial navigation system (INS) using the output of the vehicle sensor 40. The navigation HMI 52 includes a display device, a speaker, a touch panel, a key, and the like. The navigation HMI 52 may be partially or completely shared with the HMI 30 described above. The route determining part 53 determines, for example, a route (hereinafter, a route on map) to a destination input by an occupant using the navigation HMI 52 from a position of the vehicle M (or an arbitrary position that was input) specified by the GNSS receiver 51 with reference to the first map information 54. The first map information 54 is, for example, information that represents a shape of a road using links that indicate roads and nodes connected by the links. The first map information 54 may include a curvature of a road, point of interest (POI) information, or the like. The route on map is output to the MPU 60. The navigation device 50 may perform route guidance using the navigation HMI 52 on the basis of the route on map. The navigation device 50 may be realized by, for example, a function of a terminal device such as a smartphone, a tablet terminal, or the like, held by the occupant. The navigation device 50 may transmit the current position and destination to a navigation server via the communication device 20, and acquire the same route as the route on map from the navigation server.

The MPU 60 includes, for example, a recommended lane determining part 61 and stores second map information 62 in a storage device such as a HDD, a flash memory, or the like. The recommended lane determining part 61 divides the route on map provided by the navigation device 50 into a plurality of blocks (for example, divides every 100 m in terms of a direction of advance of the vehicle) and determines a recommended lane for each block by referring to the second map information 62. The recommended lane determining part 61 determines which lane from the left to travel in. The recommended lane determining part 61 determines the recommended lane for the vehicle M when a branch point exists on the route on map, so that the vehicle M can travel a reasonable route to proceed to the branch destination.

The second map information 62 is map information more accurate than the first map information 54. The second map information 62 includes, for example, information of a lane center, information of a lane boundary, or the like. In addition, the second map information 62 may include road information, traffic regulation information, address information (address and postal code), facility information, telephone number information, and the like. The second map information 62 may be updated at any time by the communication device 20 communicating with other devices.

The driving operator 80 includes, for example, a steering wheel 82 as well as an accelerator pedal, a brake pedal, a shift lever, and other operators. A sensor configured to detect an operation amount or existence of an operation is attached to the driving operator 80, and the detection results are output to the vehicle control device 100, or some or all of the traveling driving force output device 200, the brake device 210 and the steering device 220. The steering wheel 82 is an example of “an operator that accepts steering operations from the driver.” The operator does not necessarily have to be annular, it may be in the form of an irregular steer, a joystick, a button, or the like. A steering grip sensor 84 is attached to the steering wheel 82. The steering grip sensor 84 is realized by a capacitance sensor or the like, and outputs a signal to the vehicle control device 100 that can detect whether the driver is gripping the steering wheel 82 (meaning that the steering wheel is in a state in which a force can be applied).

The vehicle control device 100 includes, for example, a first controller 120, and a second controller 160. The first controller 120 and the second controller 160 are realized by executing a program (software) using a hardware processor such as a central processing unit (CPU) or the like. In addition, some or all of these components may be realized by hardware (circuit part; including circuitry) such as large scale integration (LSI), a application specific integrated circuit (ASIC), a field-programmable gate array (FPGA), a graphics processing unit (GPU), a system on chip (SOC), or the like, or cooperation of software and hardware. The program may be stored in a storage device such as an HDD, a flash memory, or the like, (a storage device including a non-transitory storage medium) of the vehicle control device 100, or may be stored in a detachable storage medium such as a DVD, a CD-ROM, or the like, in advance, or may be installed in a HDD or a flash memory of the vehicle control device 100 by mounting a storage medium (non-transitory storage medium) in a drive device.

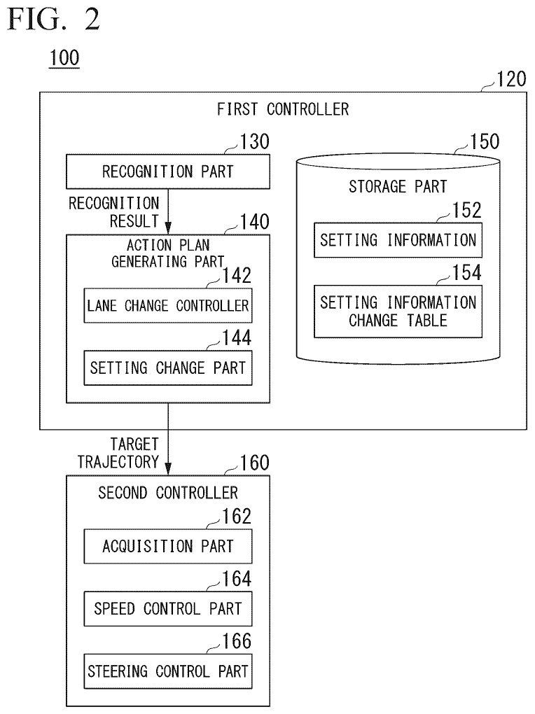

FIG. 2 is a functional configuration view of the first controller 120 and the second controller 160. The first controller 120 includes, for example, a recognition part 130, an action plan generation part 140, and a storage part 150. The action plan generation part 140 includes a lane change controller 142, and a setting change part 144. The storage part 150 is a random access memory (RAM), an HDD, a flash memory, or the like. The recognition part 130 and the action plan generation part 140 perform functions based on, for example, artificial intelligence (AI) and a pre-given model in parallel. For example, a function of “recognizing an intersection point” can be realized by performing recognition of intersection points using deep learning or the like in parallel with recognition based on pre-given conditions (such as signals and road signs that can be pattern etched), and then, assigning a score to both and evaluating them comprehensively. Accordingly, reliability of autonomous driving is guaranteed. The second controller 160 includes, for example, an acquisition part 162 configured to acquire the target trajectory, a speed controller 164 and a steering controller 166.

The recognition part 130 recognizes a state of the object around the vehicle M, such as a position, a speed, acceleration, or the like, on the basis of the information input from the camera 10, the radar device 12, and the LIDAR 14 via the object recognition device 16. The position of the object is recognized, for example, as a position on absolute coordinates using a representative point (a center of gravity, a driving shaft center, or the like) of the vehicle M as an origin, and used in control. The position of the object may be expressed by a representative point such as a center of gravity, corners of the object, or may be expressed by a region. The “state” of the object may include acceleration or jerk of the object, or “a behavioral state” (for example, whether lane change is being performed or is going to be performed).

In addition, the recognition part 130 recognizes, for example, the lane in which the vehicle M is traveling (traveling line). For example, the recognition part 130 recognizes the traveling lane by comparing a pattern of road division lines (for example, an arrangement of solid lines and broken lines) which is obtained from the second map information 62 with a pattern of road division lines around the vehicle M which is recognized from the image captured by the camera 10. Further, the recognition part 130 may recognize a traveling lane by recognizing track boundaries (road boundaries), which are not limited to the road division lines but include road division lines, shoulders, curbs, median strips, guard rails, and the like. This recognition may take into account the position of the vehicle M obtained from the navigation device 50 and the processing results from the INS. In addition, the recognition part 130 recognizes stop lines, obstacles, red signals, toll gates, and other road incidents.

When recognizing the traveling lane, the recognition part 130 recognizes the position or posture of the vehicle M with respect to the traveling lane. The recognition part 130 may recognize, for example, a deviation of the reference point of the vehicle M from the lane center and an angle of the direction of advance of the vehicle M with respect to a line connecting the lane centers as the relative position and posture of the vehicle M with respect to the traveling lane. On the other hand, the recognition part 130 may recognize the position of the reference point of the vehicle M with respect to any side end portion of the traveling lane (road division lines or road boundaries) as the relative position of the vehicle M with respect to the traveling lane.

The action plan generation part 140 automatically generates a target trajectory which the vehicle M autonomously travels (without the driver's operation) in the future so as to basically travel in the recommended lanes determined by the recommended lane determining part 61 and to avoid approaching to the objects (except for the objects which are able to run over it such as road division lines, road signs, and manholes) recognized by the recognition part 130. For example, the recognition part 130 sets a risk region with the object that output the state being set as a center of the risk region, and within the risk region, the recognition part 130 sets risk as an index value indicating a degree to which the vehicle M should not approach. The action plan generation part 140 generates a target trajectory that does not pass through any point where the risk is equal to or greater than a predetermined value. Since some objects are moving, the risk distribution is not set to one per control cycle, but is set for multiple future time points, taking into account the predicted future position of the object based on the speed of the object. The target trajectory includes, for example, a speed element. For example, the target trajectory is represented as a sequence of points (trajectory points) that the vehicle M should reach. The trajectory point is a point that the vehicle M should reach for a predetermined traveling distance (for example, a few meters) along the road, and in addition, the target speed and target acceleration are generated as part of the target trajectory for each predetermined sampling time (for example, a few tenths of a second). In addition, the trajectory point may be the position that the vehicle M should reach at each predetermined sampling time. In this case, information on the target speed and target acceleration is expressed as an interval between trajectory points.

The action plan generation part 140 may set autonomous driving events when generating a target trajectory. The autonomous driving events include a fixed speed traveling event, a low speed following traveling event, a lane change event, a diverging event, a merging event, and a takeover event, and the like. The action plan generation part 140 generates a target trajectory according to a triggered event.

The vehicle control device 100 (the action plan generation part 140) performs the following types of automatic lane changes. There are two types of automatic lane changes: automatic lane changes (1) requested by the system and automatic lane changes (2) requested by the driver. The automatic lane changes (1) are automatic lane changes for overtaking, which are performed when the speed of the preceding vehicle is slower than a certain standard compared to the speed of the vehicle, and automatic lane changes for proceeding toward the destination (automatic lane changes due to a change to a recommended lane). The automatic lane change (2) performs lane changes of the vehicle M in the direction of the operation when the driver operates the direction indicator in the case in which conditions related to speed and positional relations with surrounding vehicles and the like are met.

The second controller 160 controls the traveling driving force output device 200, the brake device 210, and the steering device 220 so that the vehicle M passes through the target trajectory generated by the action plan generation part 140 at the scheduled time.

The traveling driving force output device 200 outputs a traveling driving force (torque) to the driving wheels so that the vehicle travels. The traveling driving force output device 200 includes a combination of, for example, an internal combustion engine, an electric motor, and a gearbox, as well as an electronic control unit (ECU) that controls these. The ECU controls the above configuration according to the information input from the second controller 160 or the information input from the driving operator 80.

The brake device 210 includes, for example, a brake caliper, a cylinder configured to transmit a hydraulic pressure to the brake caliper, an electric motor configured to generate a hydraulic pressure in the cylinder, and a brake ECU. The brake ECU controls the electric motor according to the information input from the second controller 160 or the information input from the driving operator 80 so that the brake torque corresponding to the braking operation is output to each wheel. The brake device 210 may be provided with a mechanism that transmits a hydraulic pressure generated by an operation of the brake pedal included in the driving operator 80 to the cylinder via the master cylinder as a backup. Further, the brake device 210 is not limited to the configuration described above, but may be an electronically controlled hydraulic brake device that controls the actuator according to information input from the second controller 160 and transmits the hydraulic pressure of the master cylinder to the cylinder.

The steering device 220 includes, for example, a steering ECU, and an electric motor. The electric motor applies, for example, a force to a rack and pinion mechanism to change a direction of a steered wheel. The steering ECU drives the electric motor and changes the direction of the steered wheels according to the information input from the second controller 160 or the information input from the driving operator 80.

### [Automatic Lane Change]

Hereinafter, an operation and a setting change related to the automatic lane change will be described. The following description relates to exclusively “automatic lane change to proceed toward the destination (automatic lane change due to a change in the recommended lane).” The storage part 150 stores information such as setting information 152 and a setting information change table 154 as information for automatic lane change.

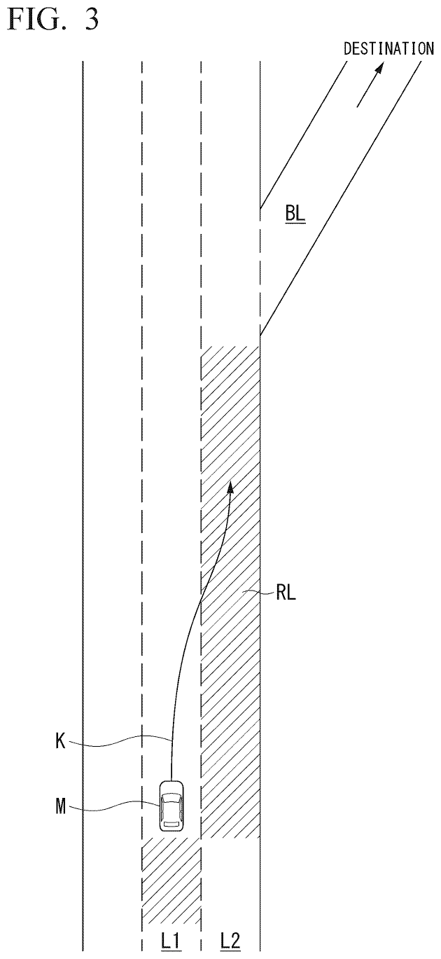

The lane change controller 142 causes the vehicle M to change lanes from a first lane L1 in which the vehicle M is located to a second lane L2 adjacent to the first lane L1, regardless of the operation of the occupant. FIG. 3 is a view illustrating a scene in which automatic lane change is performed. A diverging road BL leading to the destination set by the occupant is in front of the second lane L2, and a recommended lane RL switches from the first lane L1 to the second lane L2 in order to enter the diverging road. In the drawings, K is a route of the vehicle M in the lane change. Further, the switching timing of the recommended lane RL is set to match a length of a second time T2, so that the switching timing becomes earlier as the second time T2 is increased.

At this time, the lane change controller 142 stops the control of the lane change when a predetermined event continues during a first time T1. Here, the lane change controller 142 performs processing such as recognizing the relative position of the vehicle in the second lane and confirming the safety of the lane change from the time a trigger for a lane change occurs (as described above, for example, when the recommended lane is changed) until the second time T2 has elapsed, and controls the steering device 220 to initiate lateral movement of the vehicle M when the second time T2 has elapsed. Each of the first time T1 and the second time T2 is stored in the storage part 150 as the setting information 152. The predetermined event is, for example, when the occupant is not gripping the steering wheel 82, which is an example of a steering operator, i.e., when the occupant is in a hands-off state, or when the occupant is only lightly touching the steering wheel 82. Further, the lane change controller 142 does not discontinue the control related to the lane change when the predetermined place on the vehicle M (for example, the center of gravity or the tip portion of the front wheel on the second lane side of the left and right front wheels) crosses the road division lines between the first lane and the second lane during the first time T1, even if the predetermined event continues during the first time T1.

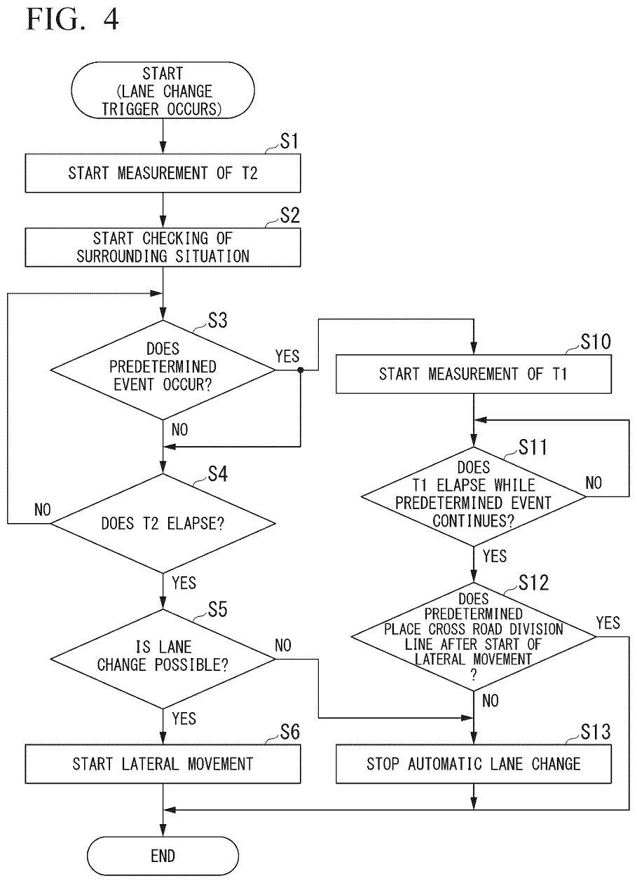

FIG. 4 is a flowchart showing an example of a flow of processing by the lane change controller 142. The processing in this flowchart begins when a lane change trigger occurs. First, the lane change controller 142 starts measurement at the second time T2 (step S1) and starts checking the surrounding situation of the vehicle M (step S2). Next, the lane change controller 142 determines whether a predetermined event has occurred (step S3). When the predetermined event has not occurred, the lane change controller 142 determines whether the second time T2 has elapsed (step S4). The processing of steps S3 and S4 is repeated until the second time T2 has elapsed.

After the second time T2 has elapsed, the lane change controller 142 determines whether the situation allows for a lane change (step S5). For example, the lane change controller 142 performs determination of step S5 on the basis of factors such as the size of the space at the lane change destination in the second lane. When the situation is such that a lane change is possible, the lane change controller 142 initiates lateral movement of the vehicle M (step S6). After that, the lane change controller 142 moves the vehicle M at a predetermined lateral movement speed until the lane change is completed.

When it is determined that the predetermined event has occurred in step S3, the lane change controller 142 performs processing of steps S10 to S13 in parallel with the processing of steps S4 to S6. The lane change controller 142 starts measurement of the first time T1 (step S10). Next, the lane change controller 142 determines whether the first time T1 has elapsed while the predetermined event is continuing (step S11). When the first time T1 has elapsed while the predetermined event is still occurring, the lane change controller 142 determines whether the vehicle M has started the lateral movement and whether the predetermined place on the vehicle M has crossed the road division lines (step S12). When a negative determination result is obtained in step S12, the lane change controller 142 stops the lane change control. Further, the lane change controller 142 also stops the automatic lane change if it is determined in step S5 that the vehicle is not in a lane change possible situation. At this time, the lane change controller 142 starts the processing again from step S1 if the lane change trigger has not been cancelled. When a positive determination result is obtained in step S12, the lane change controller 142 continues the automatic lane change without stopping it. In addition, when the predetermined event disappears after starting the measurement at the first time T1 (when the occupant grips the steering wheel 82), the lane change controller 142 resets the measurement at the first time T1 and continues the automatic lane change.

### [Setting Change]

Here, the second time T2 is set variably depending on the export destination of the vehicle M (the country to which the vehicle M is exported (domestic if it is domestic)) and then export is performed. The optimal second time T2 varies depending on the legal system and national character of the export destination, and thus, it is possible to increase user satisfaction. That is, this is because there are countries where it is necessary to change lanes early and with plenty of time to prepare for diverging roads, and countries where it is necessary to change lanes relatively just before, and it is preferable to switch control timing according thereto.

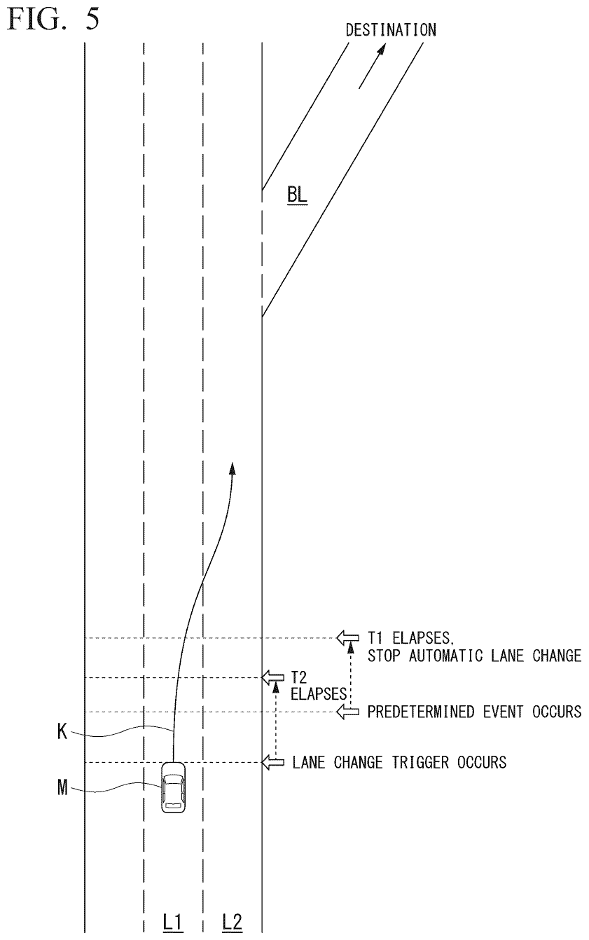

Incidentally, if only the second time T2 is made variable, there may be a scene where the occupant feels uncomfortable with the cancellation timing of the automatic lane change. FIG. 5 is a view illustrating a scene when an occupant feels uncomfortable with the cancellation timing of the automatic lane change. In this example, the second time T2 is set relatively short, and accordingly, it is set that switching of the recommended lane RL occurs relatively close to the diverging road BL. In this scene, if the first time T1 is set to be longer, as shown, the automatic lane change may be canceled when a predetermined event occurs and the first time T1 has elapsed after the vehicle M starts the lateral movement, which may cause the behavior of the vehicle M to become inconsistent and the occupant to feel uncomfortable. Accordingly, if the second time T2 is short, it is desirable to make the corresponding first time short as well.

Here, the setting change part 144 of the vehicle control device 100 changes the setting at the first time T1 on the basis of the second time T2, which is one piece of the lane change setting information. The setting change part 144 sets the first time T1 to a shorter value as the second time T2 is shorter.

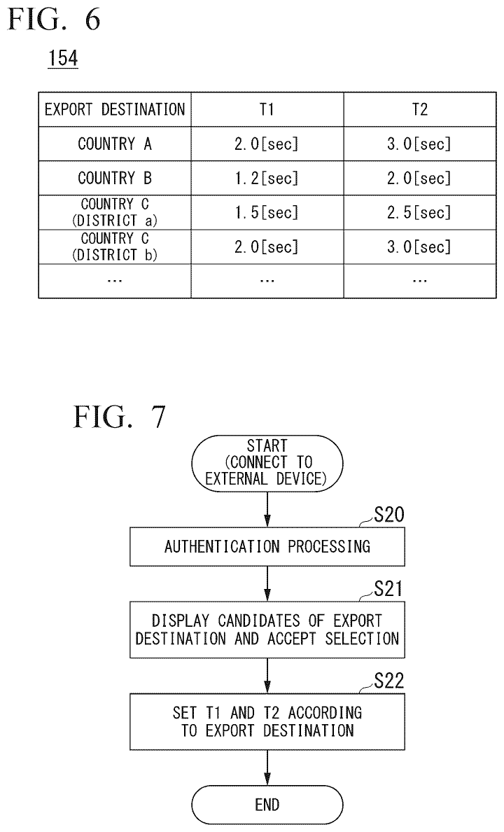

FIG. 6 is a view showing an example of the setting information change table 154. The setting information change table 154 is, for example, information that specifies a set of the first time T1 and the second time T2 for each export destination of the vehicle M. The set of the first time T1 and the second time T2 in the setting information change table 154 is defined such that the shorter the second time T2, the shorter the first time T1. The setting change part 144 changes the second time T2 so that the relationship between the first time T1 and the second time T2 defined in the setting information change table 154 is maintained.

FIG. 7 is a flowchart showing an example of a flow of processing executed by the setting change part 144. The processing of this flowchart begins when, for example, a prescribed external device is connected to the vehicle control device 100. The prescribed external device is a computer device such as a tablet terminal, a personal computer, a smartphone, or the like.

First, the setting change part 144 communicates with an external device and performs authentication processing of the external device and the operator (step S20). The setting change part 144 displays export destination candidates defined in the setting information change table 154 on the external device and accepts the operator's selection of an export destination from among them (step S21). The setting change part 144 sets the first time T1 and the second time T2 according to the selected export destination, and stores them in the storage part 150 as the setting information 152 (step S22).

By doing this, the second time T2, which is the reference time for canceling the lane change, can be set appropriately.

In the embodiment, while the setting change part 144 changes the setting of the first time T1 on the basis of the second time T2, which is one piece of the setting information of the lane change, instead of (or in addition to) this, the first time T1 may be set shorter as the lateral velocity in the lane change, which is one piece of the setting information of the lane change, becomes larger.

In addition, in the embodiment, the lane change controller 142 does not stop the control related to the lane change when the predetermined place on the vehicle M crosses the road division lines between the first lane and the second lane during the first time T1 even if the predetermined event continues during the first time T1, but instead of this, the lane change controller 142 may be configured not to stop the control related to the lane change when the vehicle M initiates the lateral movement for the lane change during the first time T1 even if the predetermined event continues during the first time T1.

The above-mentioned embodiment can be expressed as follow.

A moving body control device including:
a storage medium configured to store instructions readably by a computer (computer-readable instructions); and
a processor connected to the storage medium,
the processor executing the instructions readable by the computer to: (the processor executing the computer-readable instructions to:)
change a lane of a moving body from a first lane in which the moving body is located to a second lane adjacent to the first lane regardless of an operation of an occupant,
stop control related to the lane change when a predetermined event continues during a first time, and
change setting of the first time on the basis of setting information of the lane change.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. A moving body control device comprising:
a lane change controller configured to change a lane of a moving body from a first lane in which the moving body is located to a second lane adjacent to the first lane regardless of an operation of an occupant, the lane change controller configured to stop control related to the lane change when a predetermined event continues during a first time; and
a setting change part configured to change setting of the first time on the basis of setting information of the lane change.

2. The moving body control device according to claim 1, wherein the setting information is a second time from a time when the lane change controller determines to perform the control related to the lane change until the moving body starts a lateral movement for the lane change, and
the setting change part sets the first time shorter as the second time becomes shorter.

3. The moving body control device according to claim 1, wherein the setting information is a lateral velocity in the lane change, and
the setting change part sets the first time shorter as the lateral velocity becomes greater.

4. The moving body control device according to claim 1, wherein the setting change part changes the setting of the first time according to an export destination country of the moving body.

5. The moving body control device according to claim 1, wherein the lane change controller does not stop the control related to the lane change when a predetermined place of the moving body crosses a road division line during a first time even if the predetermined event continues during the first time.

6. The moving body control device according to claim 1, wherein the lane change controller does not stop the control related to the lane change when the moving body starts a lateral movement for the lane change during a first time even if the predetermined event continues during the first time.

7. The moving body control device according to claim 1, wherein the predetermined event is when the occupant does not grip a steering operator.

8. A moving body control device comprising:
a lane change controller configured to change a lane of a moving body from a first lane in which the moving body is located to a second lane adjacent to the first lane regardless of an operation of an occupant, the lane change controller configured to stop control related to the lane change when a predetermined event continues during a first time,
wherein the first time is set to be shorter as a second time is shorter, the second time being a time from when the lane change controller has determined to perform control related to the lane change until the moving body starts a lateral movement for the lane change.

9. A moving body control method executed by a moving body control device, the moving body control method comprising:
processing of changing a lane of a moving body from a first lane in which the moving body is located to a second lane adjacent to the first lane regardless of an operation of an occupant and stopping control related to the lane change when a predetermined event continues during a first time; and
processing of changing setting of the first time on the basis of setting information of the lane change.

10. A computer-readable non-transitory storage medium in which a program is stored to cause a processor of a moving body control device to execute:
processing of changing a lane of a moving body from a first lane in which the moving body is located to a second lane adjacent to the first lane regardless of an operation of an occupant and stopping control related to the lane change when a predetermined event continues during a first time; and
processing of changing setting of the first time on the basis of setting information of the lane change.
